(19) United States
(12) Patent Application Publication
(10) Pub. No.: US 2025/0168045 A1
(43) Pub. Date: May 22, 2025

(54) WIFI OPERATIONS USING FREQUENCY SHIFT KEYING

(71) Applicant: The Regents of The University of Michigan, Ann Arbor, MI (US)

(72) Inventors: Kang G. SHIN, Ann Arbor, MI (US); Hsun-Wei CHO, Ann Arbor, MI (US)

(73) Assignee: The Regents of The University of Michigan, Ann Arbor, MI (US)

(21) Appl. No.: 18/840,034

(22) PCT Filed: Feb. 20, 2023
(86) PCT No.: PCT/US2023/013407

§ 371 Date: Aug. 20, 2024

Related U.S. Application Data
(60) Provisional application No. 63/312,244, filed on Feb. 21, 2022.

(51) Int. Cl. H04L 27/12; H04L 27/22; H04W 84/12

(52) U.S. Cl. CPC H04L 27/12; H04L 27/22; H04W 84/12

(57) ABSTRACT

A system includes a module configured to operate in accordance to a wireless protocol that is different than a WiFi protocol and emulate direct transmission and reception of WiFi signals to and from an unmodified WiFi device, without payload selection or precoding on the unmodified WiFi device. The module includes a receiver configured to receive, from the unmodified WiFi device, an unmodified first WiFi signal having an arbitrary data packet, and a transmitter configured to transmit, to the unmodified WiFi device, a second WiFi signal. The receiver includes a narrowband filter configured to extract portions of the spectrum of the unmodified first WiFi signal from the unmodified WiFi device, and a narrowband demodulator configured to convert the extracted portions of the unmodified first WiFi signal into a plurality of bits to allow the receiver to recover the data packet from the unmodified first WiFi signal.

### CROSS REFERENCE TO RELATED APPLICATION

This application claims the benefit of U.S. Provisional Application No. 63/312,244, filed Feb. 21, 2022. The entire disclosure of the above application is incorporated herein by reference.

### FIELD

The present disclosure relates to WiFi operations using frequency shift keying.

### BACKGROUND

This section provides background information related to the present disclosure which is not necessarily prior art.

WiFi is the de facto standard for computing devices to wirelessly access the Internet using the 2.4 GHZ ISM band. The computing devices commonly include and/or connect to one or more WiFi chips to achieve wireless connectivity with the

Internet via WiFi devices (e.g., access points). WiFi chips are typically designed to support all types of Internet applications. As such, WiFi chips require a considerable amount of digital signal processor (DSP) circuitry for processing various WiFi waveforms, including high-throughput waveforms. This leads to physically large chips, high energy consumption, and high chip costs.

With increasing stringent board space and power requirements, many Internet of things (IoT) devices use power-efficient, low-cost and small wireless chips, such as Bluetooth or proprietary wireless chips. In some cases, Bluetooth and proprietary wireless chips are based on frequency-shift keying (FSK) modulation. In such examples, a mismatch of different wireless technologies is present between computing devices implementing, for example, IoT applications, Bluetooth/Bluetooth Low Energy (BLE) applications, etc. and WiFi APs. Some approaches are available to address this mismatch of different wireless technologies. For example, devices may indirectly communicate with a WiFi AP (to access the Internet) via gateways.

In other approaches, WiFi devices such as WiFi APs are modified to provide a modified WiFi signal or a non-WiFi signal to the mismatched device. For example, a conventional WiFi device may be modified into a specific transmitter for sending signals to a wireless chip (e.g., a Zigbee chip, etc.) employed in the mismatched device. In other examples, BlueFi or WiBeacon may modify a conventional WiFi device to transmit Bluetooth signals, such as BLE beacons or audio packets. Such systems aim to use WiFi to transmit Bluetooth waveforms because Bluetooth devices do not operate as a conventional WiFi client. In some examples, the Bluetooth devices can only receive WiFi packets with specifically-crafted payloads. These systems allow one-way broadcast (beacons) or one-way unicast (audio) communication from WiFi to the mismatched device. If bi-directional communication is desired, modifications must be made on the WiFi device and the mismatched device, and in some cases custom encoding.

### SUMMARY

This section provides a general summary of the disclosure, and is not a comprehensive disclosure of its full scope or all of its features.

According to one example embodiment, a system includes a module configured to operate in accordance to a wireless protocol that is different than a WiFi protocol and emulate direct transmission and reception of WiFi signals to and from an unmodified WiFi device, without payload selection or precoding on the unmodified WiFi device. The module includes a receiver configured to receive, from the unmodified WiFi device, an unmodified first WiFi signal having an arbitrary data packet, and a transmitter configured to transmit, to the unmodified WiFi device, a second WiFi signal. The receiver includes a narrowband filter configured to extract portions of the spectrum of the unmodified first WiFi signal from the unmodified WiFi device, and a narrowband demodulator configured to convert the extracted portions of the unmodified first WiFi signal into a plurality of bits to allow the receiver to recover the arbitrary data packet from the unmodified first WiFi signal for a computing device.

According to another example embodiment, a receiver of a module is configured to emulate direct reception of an unmodified WiFi signal from an unmodified WiFi device. The receiver includes a narrowband filter and a narrowband demodulator. The receiver is configured to operate in accordance to a wireless protocol different than a WiFi protocol and receive the unmodified WiFi signal having an arbitrary data packet from the unmodified WiFi device, without payload selection or precoding on the unmodified WiFi device. The narrowband filter is configured to extract portions of the spectrum of the unmodified WiFi signal received from the unmodified WiFi device, and the narrowband demodulator is configured to convert the extracted portions of the unmodified WiFi signal into a plurality of bits to allow the receiver to recover the arbitrary data packet from the unmodified WiFi signal.

According to another example embodiment, a transmitter of a module is

configured to emulate direct transmission of a WiFi signal having a standard direct-sequence spread spectrum (DSSS) data packet to an unmodified WiFi device. The transmitter includes at least one component configured to shift a phase of the transmitter based on a plurality of bits of the DSSS data packet. The transmitter is configured to operate in accordance to a wireless protocol different than a WiFi protocol and transmit the WiFi signal having the DSSS data packet to the unmodified WiFi device.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a block diagram of a modulation model of 802.11b for generating a WiFi waveform, according to one example embodiment of the present disclosure.

FIG. 1B is a flow chart for transforming a phase shift keying waveform into the WiFi waveform of FIG. 1A, according to another example embodiment.

FIG. 1C is a block diagram of a demodulation model of 802.11b for generating a data packet, according to another example embodiment.

FIG. 2A is a block diagram of a demodulation model of a FM/FSK receiver according to another example embodiment.

FIGS. 2B-E are graphs showing waveforms generated by the demodulation model of FIG. 2A, according to another example embodiment.

FIG. 3 is a graph showing output waveforms of a FSK receiver demodulating an 802.11b waveform and a standard FSK waveform, according to another example embodiment.

FIG. 4 is a block diagram of a system including a FM/FSK receiver and a descrambler, according to another example embodiment.

FIG. 5 is a flow chart of an example implementation of the descrambler of FIG. 4, according to another example embodiment.

FIGS. 6A-B are block diagrams of an 802.11b data packet and a FSK data packet, respectively, according to other example embodiments.

FIG. 7 is a configurable packet level process addressing format differences between an 802.11b data packet and a FSK data packet, according to another example embodiment.

FIGS. 8A-B are a block diagram of a typical FM/FSK transmitter and a resulting constellation graph for the transmitter operating in BPSK modulation, respectively.

FIGS. 9A-B are a block diagram of a FM/FSK transmitter and a resulting constellation graph for the FM/FSK transmitter, respectively, according to other example embodiments.

FIGS. 10-11 are timing diagrams of data transmission and reception using ACK and RTS-CTS, according to other example embodiments.

FIG. 12 is a flow chart of a finite state machine diagram for a FM/FSK implementation, according to another example embodiment.

FIG. 13 is a block diagram a system including a FM/FSK module and a microcontroller, according to another example embodiment.

FIG. 14 is a block diagram a system including multiple computing devices and an unmodified WiFi AP, according to another example embodiment.

Corresponding reference numerals indicate corresponding parts and/or features throughout the several views of the drawings.

### DETAILED DESCRIPTION

Example embodiments will now be described more fully with reference to the accompanying drawings.

A mismatch of different wireless technologies is sometimes present between computing devices implementing, for example, IoT applications, Bluetooth/BLE applications, etc. and WiFi APs. For example, IoT applications, Bluetooth/BLE applications, etc. commonly include wireless chips (e.g., 2.4 GHZ proprietary wireless chips) employing FSK modulation.

Such modulation schemes can be implemented with simple and low-power frequency modulation (FM) modules. For example, using FM circuits to transmit/receive digital waveforms, FSK chips are extremely energy-efficient and low-cost as compared to WiFi chips. Additionally, FSK chips occupy less board space than WiFi chips. For instance, a small WiFi chip may cost $3.28 and have a Tx current of 108 mA (power amplifier (PA)) and 44.6 mA (base-band (BB)) and a Rx current of 41.6 mA, whereas a small FSK chip may cost $1.18 and have a Tx current of 100 mA (PA) and 21.5 mA (BB) and a Rx current of 19.6 mA. Thus, although they differ in many ways, FSK chips are generally much smaller and cheaper, and consume less power than WiFi chips.

In conventional approaches, computing devices employing non-WiFi wireless protocols such as FSK communication protocols cannot use the WiFi infrastructure for Internet connectivity. Instead, gateways (e.g., IoT gateways) are required to relay the data to/from WiFi devices such as access points (APs) and/or other suitable devices conforming to and operating according to the standard IEEE802.11 protocol. As such, in conventional approaches, computing devices employing non-WiFi wireless protocols access the Internet indirectly (e.g., via the gateways). This gateway reliance implies that, to use any computing devices (with FSK or protocols other than WiFi), their corresponding gateways must be installed in the environment. This hampers the adoption of such devices because use of the devices require not only buying the devices but also investing, deploying, managing, etc. the gateways.

Additionally, some conventional approaches have explored employing cross technology communication (CTC) efforts to receive data from WiFi devices. These conventional approaches have been WiFi-centric. In other words, prior efforts enabled one-way communication from modified WiFi devices (e.g., WiFi APs, etc.) to unmodified FSK devices (e.g., Bluetooth devices). For example, conventional CTC efforts require modification of hardware (e.g., WiFi transmitters) to enable a precoding process that generates non-WiFi waveforms or modified WiFi waveforms (e.g., FSK-look-alike waveforms). In other conventional CTC efforts, devices (e.g., FSK devices) are required to select a desired payload (sometimes referred to as payload selection) of a received WiFi waveform to enable communication from WiFi devices.

As such, the inventors recognized a desire to implement fully emulated WiFi techniques so that FSK modules can directly communicate (bi-directionally) with unmodified WiFi devices, without requiring payload selection with the modules or precoding on the unmodified WiFi devices. The techniques focus on enabling bi-directional communication between unmodified WiFi devices and modified FSK modules to provide an FSK-centric approach for communication, instead of the conventional WiFi-centric approach. In doing so, modified FSK modules (e.g., chips) can support full WiFi modulation (PSK with DSSS). For example, FSK modules disclosed herein are configured to decode standard WiFi packets received with WiFi DSSS waveforms, not just WiFi packets with a magic payload (e.g., a pre-coded payload that results in FSK-look-alike waveforms, a selected payload, etc.), and transmit standard 802.11b DSSS waveforms, like the conventional 802.11b WiFi operations, thus allowing the use of unmodified WiFi devices.

As further explained below, the inventors recognized multiple principles about WiFi and FSK communications that can be leveraged to achieve bi-directional, direct communication between FSK modules and unmodified WiFi devices. As such, the techniques disclosed herein enable connectivity and use-cases that were previously deemed impossible. For example, the techniques allow IoT devices to directly connect to already-deployed WiFi devices and eliminate the need for IoT gateways. Additionally, because FSK chips are cheaper, smaller and more energy-efficient than WiFi chips, the techniques may provide general Internet access for mobile devices where cost, area and/or power are of great importance.

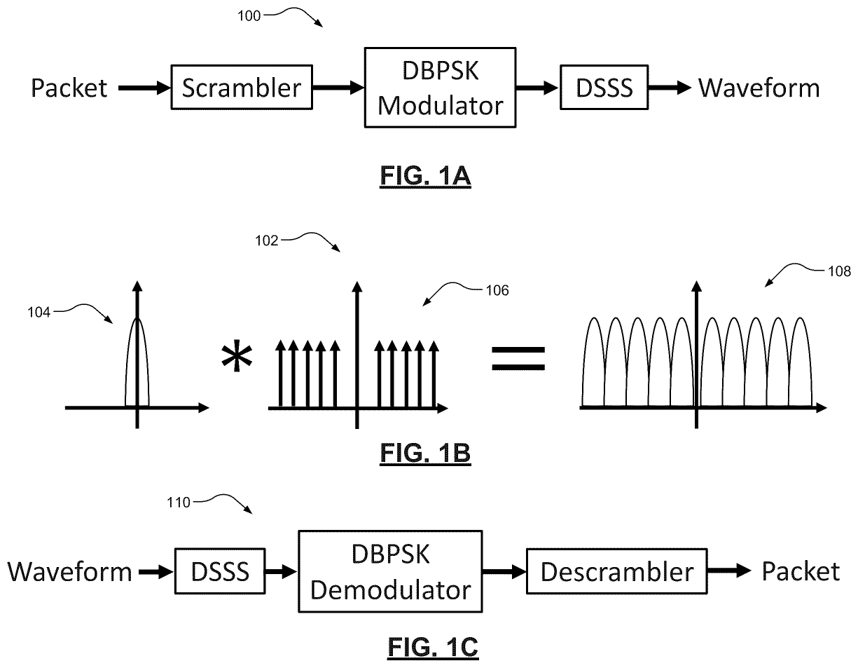

For example, one of the principles, as recognized by the inventors, about WiFi and FSK communications is that, at its core, WiFi (802.11b DSSS) encodes/decodes information in the form of phase shift keying (PSK). For example, FIGS. 1A-C illustrate various characteristics of WiFi (802.11b DSSS) encoding/decoding information in the form of PSK. Specifically, FIG. 1A illustrates an example modulation model 100 of 802.11b implemented by a WiFi transmitter. As shown, an incoming bit stream (in a data packet) is scrambled with a scrambler. The scrambled bits are then modulated by a differential binary PSK (DBPSK) modulator to generate a PSK waveform. The DBPSK modulator rotates the phase of a carrier signal by IT for bit ‘1’ or keeps the phase unchanged for bit ‘0’. The PSK waveform is then modulated using a direct-sequence spread spectrum (DSSS) module, which further toggles the phase within each bit duration using an 11-chip Barker sequence to generate a WiFi waveform.

FIG. 1B illustrates an example process 102 of transforming the PSK waveform into the WiFi waveform of FIG. 1A. The process 102 is shown in a frequency domain that corresponds to a time domain of FIG. 1A. For example, the process 102 includes multiplying a PSK waveform 104 (e.g., the PSK waveform output from the DBPSK modulator of FIG. 1A) by a sequence 106 of digital values (e.g., the 11-chip Barker sequence in the DSSS module of FIG. 1A) to obtain a WiFi waveform 108.

FIG. 1C illustrates an example demodulation model 110 of 802.11b implemented by a WiFi receiver. As shown, an incoming WiFi waveform passes through a DSSS module and a DBPSK demodulator for demodulating the received waveform. The demodulated signal is then passed to a descrambler to extract a data packet.

Another principle, as recognized by the inventors, about WiFi and FSK communications is that differential PSK (phase-shift keying) modulation is similar to frequency modulation (FM). Conceptually, the differential of phase is frequency. Additionally, at the bit level, FSK is simply frequency modulation with digital data. In other words, FSK sends digital (high or low) data into an FM modulator. Thus, differential PSK modulation is substantially similar to FSK (frequency-shift keying) modulation. One difference between differential PSK modulation and FSK modulation is that, in FSK, the phase is constantly (e.g., gradually) increasing or decreasing for the duration of each bit, whereas in DPSK, the phase remains constant and only changes between (e.g., across) bits. This difference can be mitigated with appropriate filtering as further explained below. As such, for WiFi to FSK communication, the inventors recognized that WiFi signals can be demodulated by FSK receivers (with an optional frequency shift if needed as further explained below), as further explained below.

For example, at the bit level, the inventors recognized FSK hardware can be used to receive WiFi frames with arbitrary payloads. As such, FM/FSK receivers may work as a DSSS and a DBPSK demodulator, as referenced above relative to FIG. 1C. For example, with the techniques disclosed herein, instead of using a conventional PSK demodulator (which involves much more complicated phase synchronization), a simple, low-power FM demodulator may be used. Further, the addition of DSSS requires conventional demodulators to run at a significantly higher speed (e.g., 11 MHz). With the techniques disclosed herein, the FM demodulator may run at a much lower speed (1 MHZ). Therefore, the disclosed techniques allow for the demodulation of conventional WiFi frames in a much simpler and more power-efficient fashion.

The intuition behind this method is that the DSSS modulation process is essentially, in the frequency domain, convoluting the PSK spectrum with the spectrum of a repeated 11-length Barker sequence. Note that an 11-length Barker sequence has a white spectrum and the spectrum of a repeated 11-length Barker sequence is only non-zero at +1, +2, +3, +4, +5 MHz. The convolution process simply copies the PSK spectrum and places the replicas at these frequencies. Therefore, if a relatively narrow filter (e.g., a narrowband filter) is employed to the DSSS waveform near one of the frequencies, the result is approximately the main lobe of the PSK spectrum.

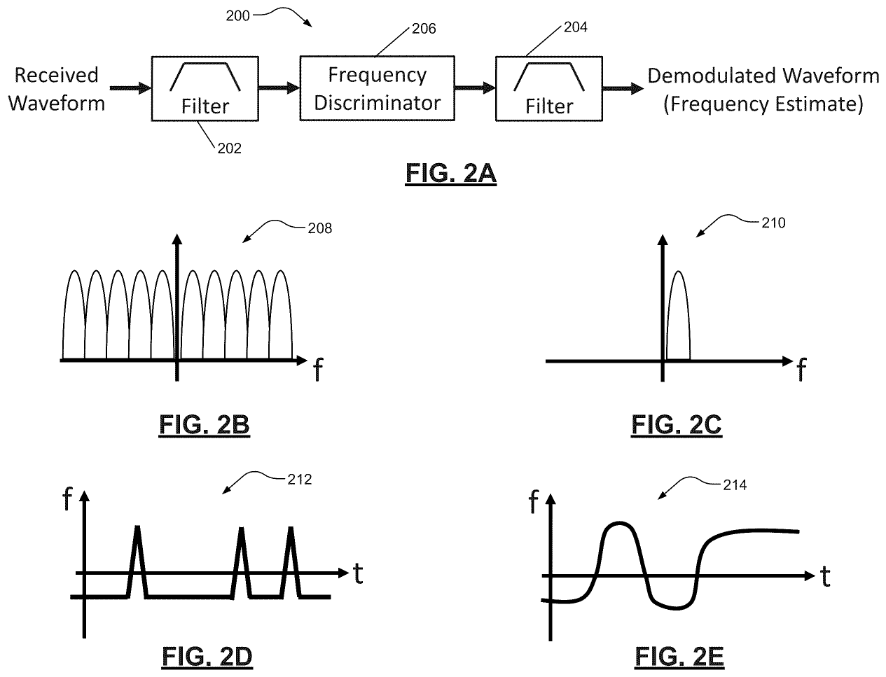

FIGS. 2A-E illustrate various characteristics of FSK. Specially, FIG. 2A illustrates an example general model 200 of a FM/FSK receiver, and FIGS. 2B-E illustrates waveforms 208, 210, 212, 214 generated by components in the FM/FSK receiver model 200.

As shown in FIG. 2A, the FM/FSK receiver model 200 includes filters 202, 204, and a frequency discriminator (e.g., a narrowband frequency demodulator) 206 between the filters 202, 204. In various embodiments, one or both filters 202, 204 and/pr the frequency discriminator 206 may be implemented in software (e.g., DSP codes, etc.) or hardware circuitry. The filter 204 (e.g., a narrowband filter) is beneficial because the frequency discriminator 206 may be a nonlinear component. In the example of FIG. 2A, the filters 202, 204 and/or the frequency discriminator 206 may be implemented in analog and/or digital domains. Additionally, in some examples with different radio architectures (e.g., zero-IF, low-IF, etc.), a frequency conversion (e.g., a down-conversion or an up-conversion) between these components may be employed.

In the example of FIG. 2A, the filter 202 receives the waveform (or signal) 208 having an arbitrary data packet (e.g., an unmodified WiFi waveform or signal) of FIG. 2B, and extracts portions of the signal near a receive frequency to generate the waveform 210 of FIG. 2C. As shown, the waveform 210 recovered from the filter 202 is the same as the PSK waveform 104 output from the DBPSK modulator of FIGS. 1A-B. As such, the filter 202 extracts a WiFi PSK waveform (e.g., the waveform 210) from the unmodified WiFi waveform 208 (e.g., a frequency modulated signal).

The frequency discriminator 206 converts the extracted portions of the signal into bits. For example, the frequency discriminator 206 demodulates the frequency modulated waveform 210 (e.g., the extracted WiFi PSK waveform) to recover bits from the received waveform 208. The recovered bits are represented graphically in the waveform 212 (e.g., a demodulated PSK waveform) of FIG. 2D. For example, the frequency discriminator 206 estimates the received waveform's instantaneous frequency, which corresponds to the original digital data in the received waveform 208. For instance, the instantaneous frequency depends on the data input level. For bit ‘1’, the frequency is higher than the center frequency by one frequency deviation. For bit ‘0’, the frequency is lower than the center frequency by one frequency deviation. In various embodiments, the frequency discriminator (demodulator) 206 may be a PSK demodulator, a FSK demodulator or variants thereof. One example of a variant of a FSK demodulator includes (but is not limited to) a Gaussian frequency-shift keying (GFSK) demodulator.

The filter 204 smooths the waveform 212 to allow the FM/FSK receiver to recover a data packet from the waveform 208. For example, the filter 204 may smooth the waveform 212 (e.g., a step-like phase waveform) of FIG. 2D into the waveform 214 (e.g., a constantly increasing or decreasing phase waveform) of FIG. 2E. This mitigates the difference between FSK and DPSK referenced above. By employing the filter 204, the demodulated waveform 214 becomes similar to a standard, demodulated FSK waveform.

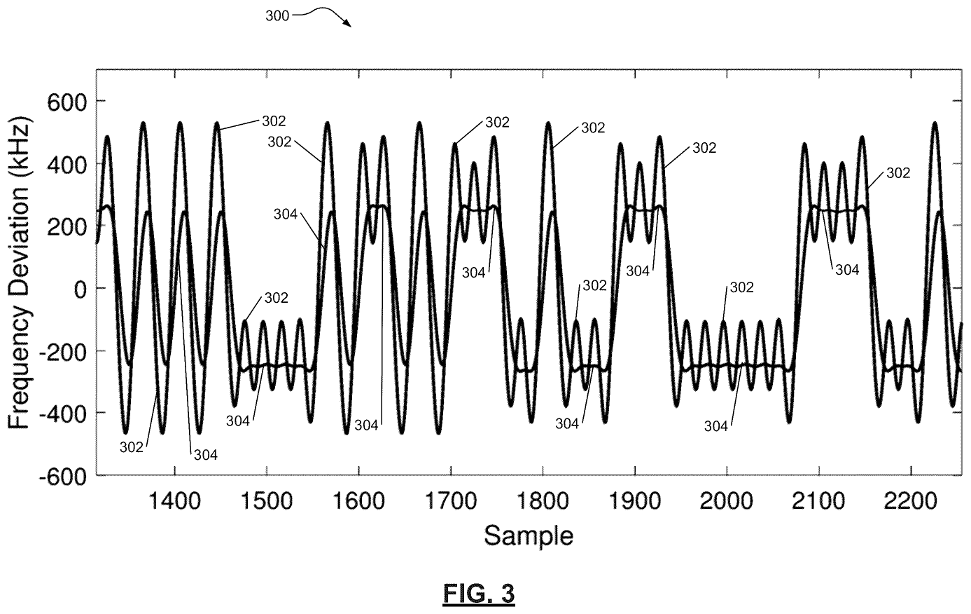

For example, FIG. 3 illustrates a graph 300 showing output waveforms 302, 304 of a FSK receiver demodulating an 802.11b waveform and a standard FSK waveform. For instance, the FM/FSK receiver model 200 of FIG. 2A may be used to demodulate a standard 802.11b (modulated) waveform into the output waveform 302. In such examples, the FM/FSK receiver 200 may have an optional frequency offset (e.g., a frequency shift), and the filters 202, 204 may be low-pass filters. In the example of FIG. 3, the illustrated segment of the waveform 302 corresponds to bit 67 to bit 113 of DBPSK bits, which are 10101010000010110101110010001110000000111100010. The waveform 304 shows the FSK demodulation results when these bits are instead modulated with FSK (e.g., using the same modulation parameters as BLE), and demodulated without the frequency offset. Although the waveform 302 tends to have higher overshoot than the waveform 304, the correct bit sequence is still clearly visible, indicating that FSK receivers can indeed be used as WiFi receivers.

In some embodiments, the FM/FSK receiver may operate at a frequency equal to the frequency of the unmodified WiFi signal. In other embodiments, the FM/FSK receiver may operate at a frequency shifted (e.g., a frequency offset) by a defined amount with respect to the frequency of the unmodified WiFi signal. For example, the frequency shift may be any suitable amount including positive or negative shifts, fractional shifts, etc. with respect to the frequency of the unmodified WiFi signal. In some examples, the optional frequency shift may be 1 MHZ, 1.22 MHZ, etc.

The optional frequency shift may be added to the FM/FSK receiver (e.g., the FM/FSK receiver 200) to ensure the FM/FSK receivers can work as the DSSS and the DBPSK demodulator. For example, a small frequency shift may be required because an FSK receiver expects the frequency deviation of each bit to be either positive or negative. However, with DBPSK waveforms, the frequency deviation is either zero (no phase change) or non-zero (phase change). This can be corrected using a small amount of frequency shift, which equivalently adds a constant bias to the frequency deviation of each bit, and converts the frequency waveform to be non-return-to-zero. In some embodiments, applying such frequency shifts requires no additional hardware. For example, a simply change the center frequency of the FSK receiver may effectively apply an adequate frequency shift.

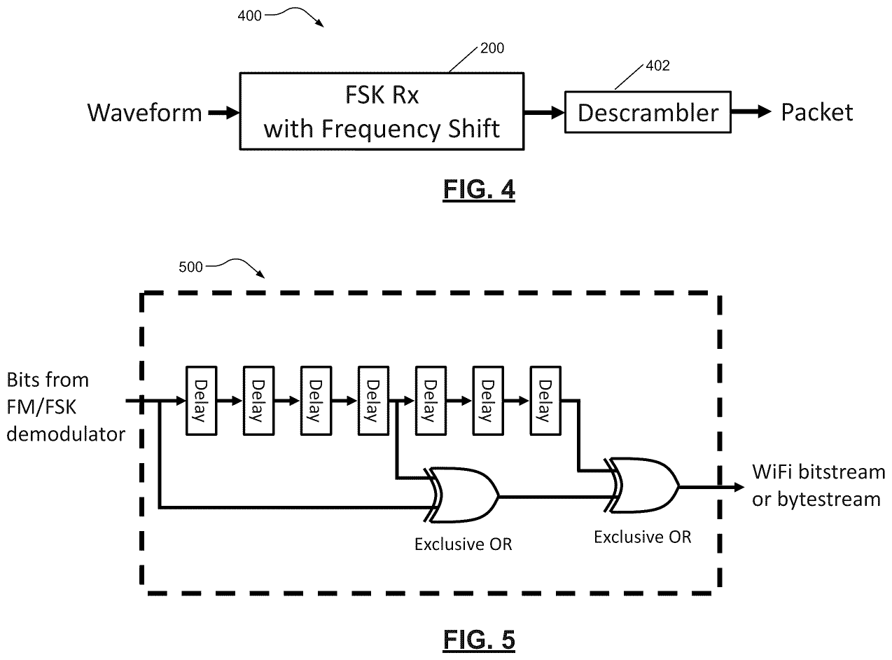

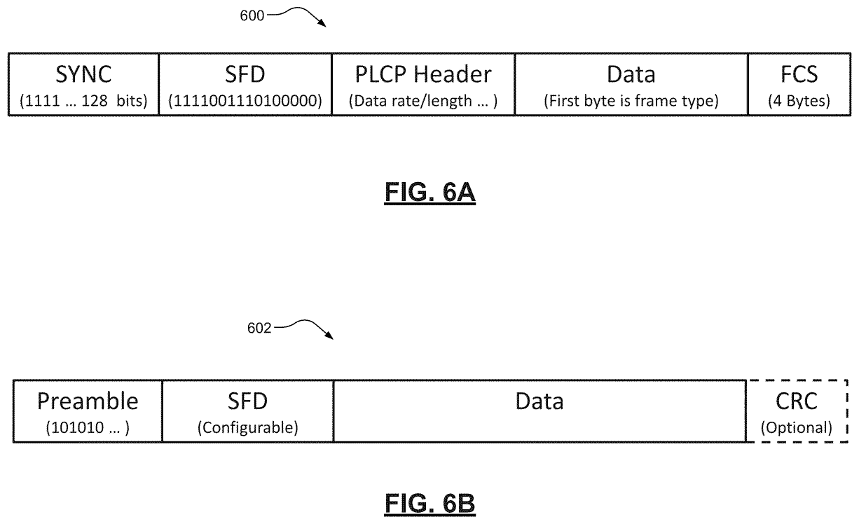

With the FSK hardware replacing the DSSS and the DBPSK demodulator, the only step left for recovering the WiFi bits is descrambling the bit stream. For example, FIG. 4 illustrates a system 400 including the FM/FSK receiver 200 of FIG. 2A implementing a frequency shift, and a descrambler 402 coupled to the FM/FSK receiver 200 (e.g., to the filter 204 of the FM/FSK receiver 200). The descrambler 402 may be configured to recover a data packet from demodulated WiFi bits in a bit stream of a demodulated waveform generated by the FM/FSK receiver 200. The descrambling process implemented by the descrambler 402 may be relatively simple. For example, in some embodiments, the descrambling process may be done in batch to each byte or word, and may not require extracting/reassembling bits to process them one-by-one.

FIG. 5 illustrates one example implementation of a descrambler 500 that may be employed as the descrambler 402 of the FIG. 4. For example, the descrambler 500 may employ an 802.11b descrambling process that is simplified as XOR'ing the input with two shifted versions of the input, as shown in FIG. 5. Specifically, bits (e.g., a serial data input) from a FM/FSK demodulator are input to the descrambler 500, and a WiFi bitstream or bytestream (e.g., a serial data output) is output from the descrambler 500. As shown, the process includes XOR'ing the input with two shifted versions (e.g., Z⁻⁴ and Z⁻⁷) of the input. In such examples, with the least-significant-bit-first ordering, the descrambling process may involve only 4 lines of code: reg=(descrambling_in<<8)|lastbyte; reg2=reg\hat{ }(reg>>3)\hat{ }(reg>>7); descrambling_out=0xFF & (reg2); lastbyte=descrambling_in.

Although FIG. 5 illustrates a specific implementation of the descrambler 500, it should be apparent that any suitable implementation of a descrambler with polynomial G(z)=Z⁻⁷+Z⁻⁴+1 may be employed.

Even with a successful bit-level communication from WiFi to FSK hardware as explained above, there is still a need to address the differences in formats between 802.11b packets and FSK packets to successfully receive a WiFi packet. The format differences are shown in FIGS. 6A-B.

For example, FIG. 6A illustrates an example 802.11b packet 600. As shown in FIG. 6A, the 802.11b packet 600 includes a SYNC field, a constant start frame delimiter (SFD) field, a physical layer convergence protocol (PLCP) header field, a data field, and a frame check sequence (FCS) field. The SYNC field includes 128 bits of ‘1’, which are used to stabilize the receiver. The constant SFD follows the SYNC field and is used by the receiver to detect the start of a WiFi packet. The PLCP header contains vital information about the modulation and the total length of subsequent fields, and a 16-bit cyclic redundancy check (CRC) for detecting errors in the header. Upper-layer packets are put into the data field. The FCS field uses a CRC32 function and is calculated over the data field.

FIG. 6B illustrates an example FSK packet 602. As shown, the FSK packet 602 includes a preamble field, a configurable SFD field (e.g., sometimes referred to as “sync word” in FSK protocols), a data field, and an optional CRC field. The preamble field includes alternating 1's and 0's so that a frequency discriminator (e.g., the frequency discriminator 206 of FIG. 2A) in the FSK receiver can be stabilized. In FIG. 6B, the preamble field includes “101010. . . ” as an example of the alternating 1's and 0's. In other examples, the preamble field may include “010101. . . ” if desired. In the example of FIG. 6B, the preamble is followed by the configurable SFD field, which notifies the receiver that it should expect and start collecting actual data (in the data field) after it receives SFD. If CRC is enabled, a CRC sequence (in the CRC field) is appended to the data field for detecting bit errors.

In some examples, and as further explained below, a FM/FSK receiver may detect (e.g., recognize) a packet by detecting a bit sequence in an unmodified WiFi signal. For example, all or a portion of the (scrambled) WiFi SYNC waveform/bit sequence may be used to allow the FM/FSK receiver to detect (e.g., recognize) WiFi packets. This this may be accomplished by configuring the SFD (the “sync word” in the FM/FSK receiver) as all or the portion of the WiFi SYNC bit sequences, their complement, or any similar bit sequences (i.e., with a few bit flips), so that the FM/FSK receivers will be activated once WiFi packets are received. In other examples, all or a portion of the PLCP waveform/bit sequence, the (scrambled) WiFi SFD waveform/bit sequence, etc. may be used instead of the (scrambled) WiFi SYNC if desired.

More specifically, the 802.11 standard explicitly specifies the constant seed that an 802.11b transmitter should use. Because the scrambler seed is always the same, the scrambled SYNC sequence is always the same bit sequence, no matter which specific WiFi chip is employed. Additionally, during reception, conventional WiFi chips detect a WiFi packet by matching the SFD pattern (which follows the SYNC field) in the descrambled DBPSK sequence.

With the techniques disclosed herein, the FSK demodulator outputs the scrambled WiFi DBPSK sequence. Because the (scrambled) WiFi SYNC field is always the same sequence, WiFi packets may be detected by directly matching a pattern in the scrambled sequence instead of the descrambled sequence. This design allows use of the configurable SFD matching hardware in FSK chips, which is significantly more efficient. Since the matching circuit in FSK chips expects alternating 1's and 0's preceding the SFD to stabilize the demodulator, a bit sequence is matched within the scrambled WiFi SYNC field instead of matching the scrambled WiFi SFD.

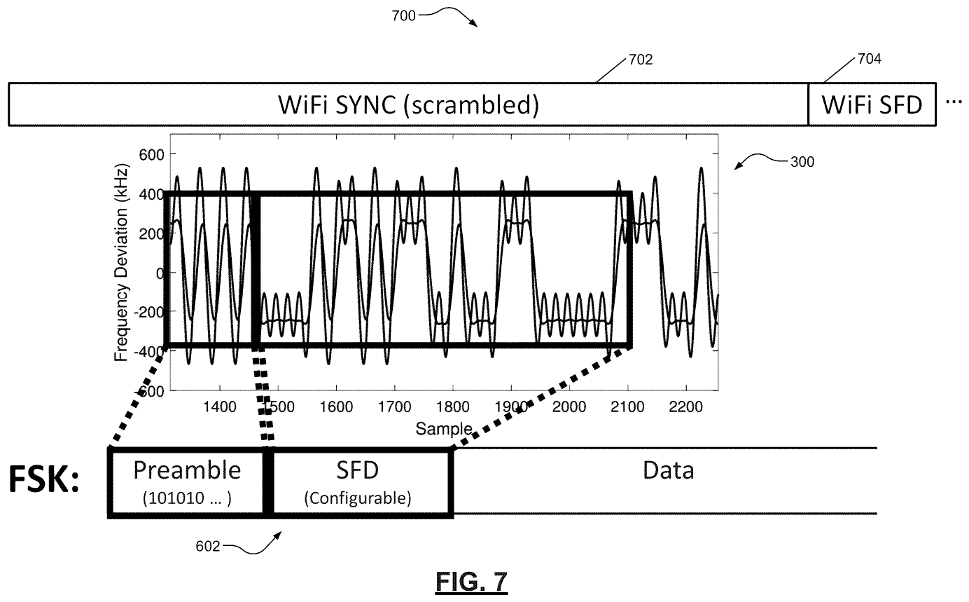

By way of example only, FIG. 7 illustrates a configurable packet level process 700 including the graph 300 of FIG. 3, a portion of an 802.11b packet having a (scrambled) WiFi SYNC field 702 and a WiFi SFD field 704, and a portion of the FSK packet 602 of FIG. 6B. The (scrambled) WiFi SYNC field 702 and the WiFi SFD field 704 may correspond to the SYNC field and the SFD field of the 802.11b packet 600 of FIG. 6A.

In the example of FIG. 7, bit 67 to bit 73 of the DBPSK bit stream in the (scrambled) WiFi SYNC field 702 may be [1,0,1,0,1,0,1] and bit 74 to bit 105 73 of the DBPSK bit stream may be 0x05AE4701. Additionally, the SFD field (sometimes referred to as the “sync word” in FM/FSK receivers) may be configured as having the same bit sequence between bit 74 to bit 105of the DBPSK bit stream. In such examples, the FM/FSK receiver may be configured to search for the 0x05AE4701 bit sequence, and once that sequence is detected, the FM/FSK receiver may continuously put subsequent bytes into the receive FIFO. These bytes can be periodically retrieved and descrambled to recover the WiFi packet. The reception may be terminated once the number of bytes received reaches the length specified in the PLCP header of the 802.11b packet. In other embodiments, reception may not be terminated early depending on, for example, hardware constraints. For example, some modules (e.g., chips) may have a shorter transition time and do not need to terminate the reception early.

In some examples, the scrambled SYNC sequence may have more or less bits than expected due to, for example, a bug in a WiFi chip. In such examples, the techniques disclosed herein may dynamically detect and fix the bug. For example, after descrambling, the last byte of the WiFi SYNC field may be checked. This byte should be 0xFF, as specified in the standard. If, however, the last byte is another value, the number of surplus or short bits can be identified based on that other value, and the bug can be rectified. For example, if the last byte is 0x3F, this indicates that the SYNC field is 2 bits shorter. In such examples, 2 bits of the configurable SFD field in the FSK packet may be shifted to this byte (since WiFi transmits least significant bits first). As such, if the bug is detected in this example, a shift of 2 bits is applied to all subsequence bytes.

Additionally, and as explained above, the tail of each WiFi packet is 4 bytes in the FCS field, which is the CRC32 of the data field. The 4 bytes in the FCS field are used to check the integrity of the received packet and if the calculated FCS does not match the received FCS, the receiver should not acknowledge this packet and the transmitter will re-transmit the packet. The implementation of an FCS field in the FSK packet is fairly straightforward. For example, a CRC sequence may be appended to the data field in the FSK packet as explained above. Additionally, in some examples, table-based calculations and updates to the CRC immediately after receiving each byte may be employed.

Another principle, as recognized by the inventors, about WiFi and FSK communications is that, for FSK to WiFi communication, PSK (phase-shift keying) with DSSS signals can be transmitted from a transmitter by shifting a phase of the transmitter based on bits of a data packet. In such examples, the transmitter may be a narrowband transmitter, such as a FSK transmitter or variants thereof including (but is not limited to) a Gaussian frequency-shift keying (GFSK) transmitter. In various embodiments, the phase shifting may be implemented by controlling one or more phase-shifting components, such as one or more mixers, phase shifters, RF switches, phase lock loops (PLLs). As such, and as further explained below, a transmitter in a FM/FSK module may transmit a WiFi signal (e.g., a DSSS signal) with a desired data packet.

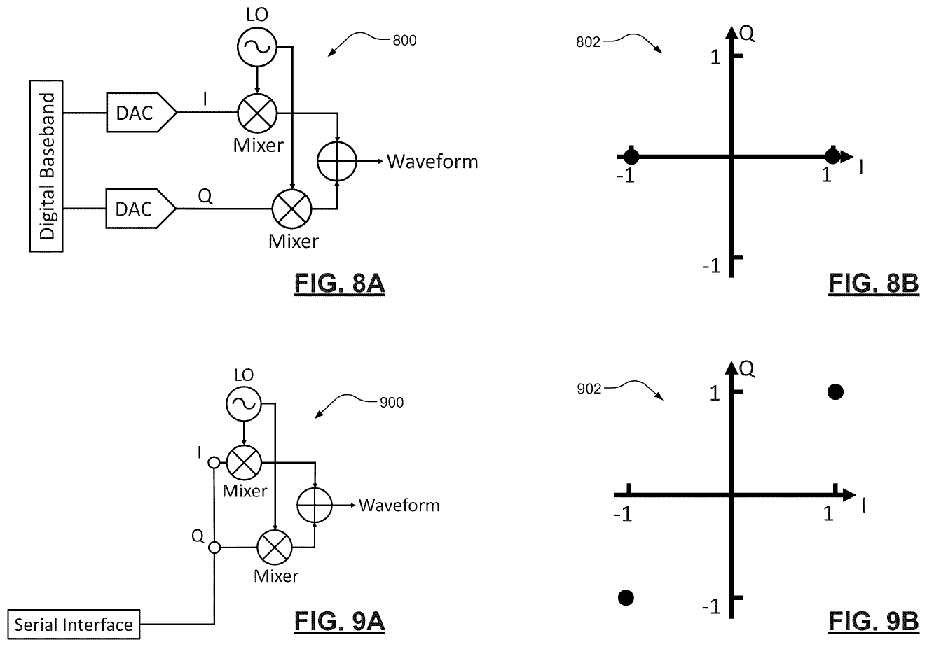

For example, FIG. 8A illustrates an example of a typical FSK transmitter 800, and FIG. 8B illustrates an example BPSK constellation graph 802 used with the transmitter 800 of FIG. 8A. As shown, the transmitter 800 of FIG. 8A includes a digital baseband, two digital-to-analog converters (DACs), an I-branch mixer, a Q-branch mixer, and a local oscillator (LO). The local oscillator (LO) generates a steady carrier wave (e.g., a pair of unmodulated sine waves oscillating at 2.4 GHz) that is provided to the I-branch mixer and the Q-branch mixer, where PSK modulation occurs. When the constellations of FIG. 8B are fed into the IQ modulator, the digital bit stream (that swings to either 1 or −1) is essentially fed into the I-branch mixer of the transmitter in FIG. 8A, and the Q-branch mixer is turned off. This is because the value of I swings between 1 and −1, and the value of Q remains 0.

By convention, BPSK constellations are (1, 0) and (−1, 0), as shown in FIG. 8B. These BPSK constellations are 180° apart, and involve three voltages (−1, 0 and 1). However, in some examples, a simpler implementation may be employed. For example, inputs to the I-branch and Q-branch mixers may be tied together. In such examples, WiFi bits (after scrambling and differential coding) may be directly fed into the mixers. With this example implementation, the constellations become (1, 1) and (<1, −1), which are still 180° apart but only involve two voltages (−1 and 1). Furthermore, the output gets 3 dB stronger using both branch mixers, instead of only the I-branch mixer in FIGS. 8A-B.

This simpler implementation may be employed in transmitting PSK waveforms using FSK hardware. In doing so, the digital baseband and DACs of FIG. 8A may be bypassed (e.g., turned off). For example, FIG. 9A illustrates an example FM/FSK transmitter 900 for transmitting PSK waveforms, and FIG. 9B illustrates an example constellation graph 902 with constellations at (1, 1) and (−1, −1). These constellations are 180° apart but only involve two voltages (−1 and 1).

The FM/FSK transmitter 900 of FIG. 9A is substantially similar to the transmitter 800 of FIG. 8A, but with inputs of the I-branch and Q-branch mixers tied together. In the example of FIG. 9A, a digital baseband and DACs are turned off and therefore removed from the figure for clarity. With this implementation, WiFi bits (after scrambling and differential coding), which swing to either 1 or −1 based on the constellations of FIG. 9B, are directly injected into both the I-branch mixer and the Q-branch mixer. This can be achieved using, for example, analog pins of a FSK chip. The local oscillator (LO) of FIG. 9A generates a steady carrier wave that is provided to the I-branch mixer and the Q-branch mixer. The mixers then generate a PSK waveform based on a bit stream (e.g., in a data packet).

Alternatively, the conventional constellations of FIG. 8B may be employed in transmitting PSK waveforms using FSK hardware. In such examples, inputs of the I-branch and Q-branch mixers (e.g., the mixers of FIG. 9A) are not tied together, and the constellations (1,0) and (−1,0) of FIG. 8B may be injected into the mixers in FSK hardware. In other examples, FSK hardware (e.g., FM/FSK transmitters) may only use one branch. For instance, some FM/FSK transmitters only rely on the I-branch. In such examples, the Q injection point and the Q mixer of FIG. 9A may be eliminated.

Additionally, 802.11 implementation uses DSSS after PSK modulation. A PSK signal with DSSS is still a PSK signal, only faster. Conceptually, before DSSS, either 1 or −1 is injected into the mixer every 1 μs. After DSSS, 10110111000 or 01001000111 is injected every 1 μs, which translates to a chip rate of 11 MChip/s.

To generate the bit stream at 11 Mbps, a serial interface (such as a serial peripheral interface (SPI), a synchronous serial port (SSP), a universal synchronous and asynchronous receiver-transmitter (USART), an I²S, etc.) in microcontrollers can be used. These serial interfaces are also commonly double buffered, ensuring that bits are transmitted continuously and precisely. In fact, in some microcontrollers, a SSP may have 8 transmit buffers. At the packet level, packets may be assembled according to the 802.11b format. One example of a serial interface for generating a bit stream for the I-branch and Q-branch mixers is shown in FIG. 9A.

Further, in WiFi, the transmission and reception of signals operate in half-duplex. In other words, WiFi data packets are sent back and forth in sequence. Data cannot be both sent and received simultaneously. In such examples, a WiFi device should avoid transmitting signals when other devices are transmitting. WiFi uses carrier-sense a multiple access with collision avoidance (CSMA/CA) process in a medium access control (MAC) layer. This CSMA/CA process senses the spectrum before transmission and waits if a wireless carrier is present.

Typical FM/FSK hardware is capable of sensing the spectrum with, for example, received signal strength indicator (RSSI) or another carrier sensing hardware. For example, when in a receive mode, FSK chips may provide received signal strength indicator (RSSI) estimates. As such, RSSI or another carrier sensing hardware on the FM/FSK hardware may be used to implement a MAC layer (e.g., a CSMA/CA to coordinate transmission and reception) that is compatible to the WiFi MAC layer.

Moreover, in typical WiFi systems, most of the packet handling is implemented in the driver or software layers, and are not timing critical. However, two exceptions are an acknowledgment (ACK) and a request to send/clear to send (RTS-CTS), which are subject to a very tight timing constraint, and hence usually handled by hardware.

For example, except for some special packets, normal unicast packets in WiFi need to be acknowledged immediately. Failure of acknowledging a packet results in the sender constantly re-transmitting the same packet, which severely decreases the goodput. Furthermore, when a client tries to join a network, it must acknowledge the association response sent by a WiFi device. Otherwise, the WiFi device de-authenticates the client and a connection cannot be established.

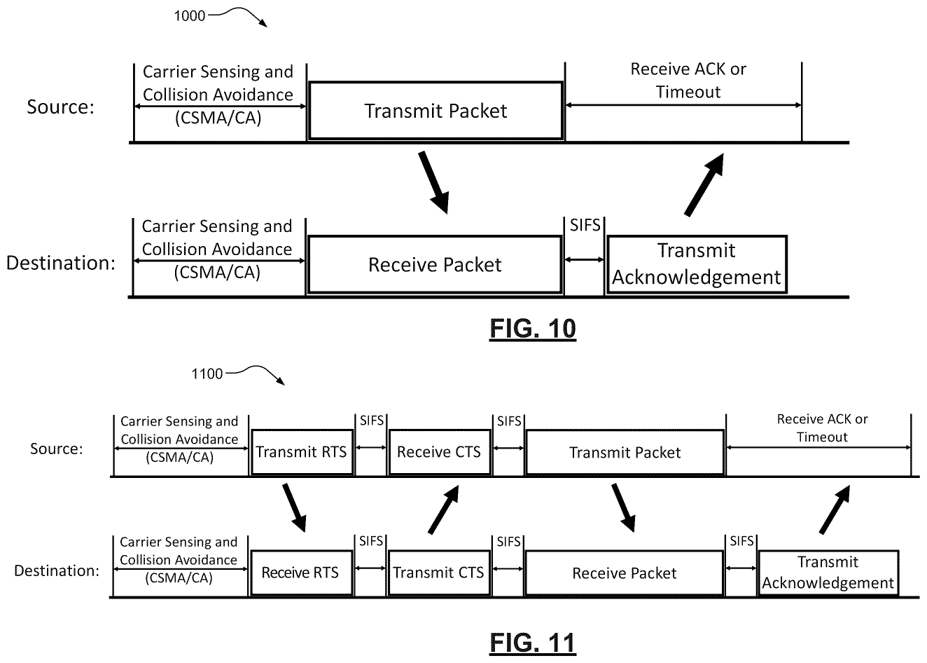

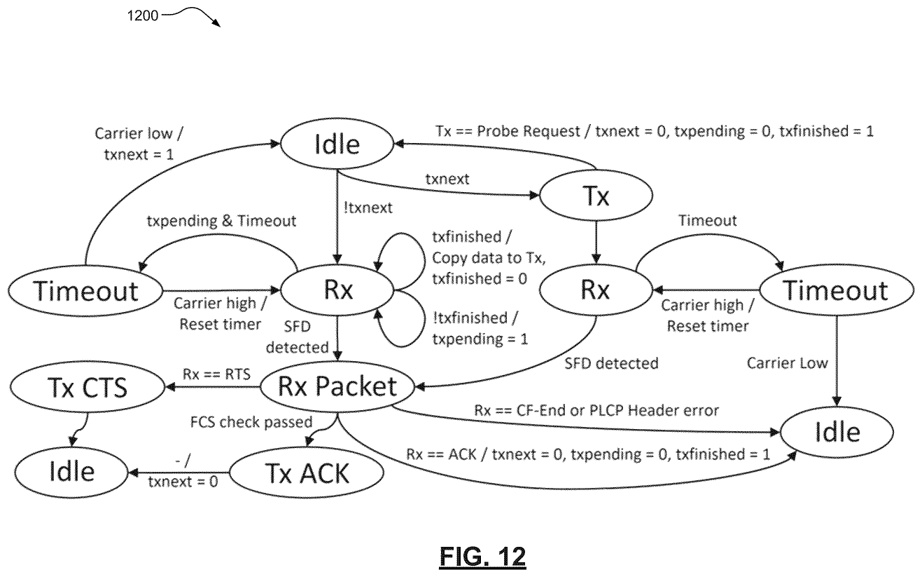

For example, FIG. 10 illustrates an example timing diagram 1000 of data transmission/reception when ACK is employed. As shown, the diagram 1000 includes a source (e.g., a sender) and a destination (e.g., a receiver). At the source, the diagram 1000 includes a carrier-sense multiple access with collision avoidance (CSMA/CA) process before a data frame. In some embodiments, the CSMA/CA may define one or more delays such as a distributed interframe space (DIFS) or an extended inter frame space (EIFS). If the CSMA/CA process determines that the spectrum is idle, a packet is transmitted during the data frame. At the destination, the diagram 1000 includes a short interframe space (SIFS) and an ACK frame that is transmitted to the sender after the receiver receives the packet.

In the example of FIG. 10, the source may be a FSK device or a WiFi device, and the destination may be a WiFi device or a FSK device. Temporally, an FSK device may switch between the source and the destination.

According to the 802.11 standard, the ACK frame should be transmitted by the receiver one SIFS after it receives the packet that passes an FCS check. 802.11b has a very short SIFS (e.g., 10 μs). The standard also specifies the ACKTimeout, which is SIFS (10 μs)+aSlotTime (20 μs)+Preamble/Header (192 μs). This timeout value is measured with respect to the end of the header of the ACK packet. Thus, when measured with respect to the start of the preamble, the time interval between a packet and its ACK packet should ideally be less than 30 μs.

According to testing, the Rx-to-Tx turnaround time of FM/FSK hardware may range around 30˜40 μs. In some instances, for WiFi devices of some WiFi manufactures, the ACK packets sent can be successfully detected without any further design or modification. As such, no workaround is needed for connecting to such WiFi devices.

However, WiFi hardware of other manufactures may be sensitive to the ACK timing. For example, WiFi hardware of some manufactures can only detect ACK frames transmitted within a very short time (e.g., ideally just less than 10 μs). Because the timeout specified in the standard is determined by the reception of the ACK header (not by the start of the ACK preamble), it is possible to start the ACK preamble late but transmit less scrambled 1's to meet the deadline. However, such a design has little effect with timing sensitive FM/FSK hardware. For example, without detecting the ACK, such FM/FSK hardware may re-transmit the same packet over and over again, essentially reducing the goodput to 0.

Instead, the inventors recognized a solution that meets the timing requirements of various WiFi products. This solution leverages the facts that a) the tail of WiFi packets is the 4-byte FCS and not the actual payload, and b) a higher layer either has additional error checking (e.g., TCP, even UDP, has checksums), or naturally anticipates occasional errors. Specifically, to accommodate the higher turnaround time (around 30˜40 μs) of FM/FSK hardware, the FM/FSK hardware may terminate (e.g., truncate) the reception of WiFi packets early to allow the transition to transmission state (e.g., its transmit mode) for the transmission of acknowledgement packets. In some examples, the FM/FSK hardware may terminate the reception after receiving 1 byte of FCS, thus reserving more time for the FSK to transition to its transmit mode for ACK. The 1 byte of FCS may be still used to check the integrity of the packet and determine whether an ACK packet should be transmitted. In other embodiments, reception may not be terminated early depending on, for example, hardware constraints. For example, some modules (e.g., chips) may have a shorter transition time and do not need to terminate the reception early in order to satisfy the WiFi timing.

An alternative design may be to only acknowledge the re-transmitted packets and performing a full FCS check on the first packet. However, this will decrease the throughput by half due to re-transmissions.

Additionally, in some examples, ACK packets may be pre-generated to help accommodate the higher turnaround time (around 30˜40 μs) of FM/FSK hardware. For example, ACK packets are always the same for a given (source) MAC address. As such, instead of generating the ACK on the fly, it is possible to pre-generate the ACK bits before sending the authentication packet to the WiFi device and reuse those ACK bits for all subsequent packets. This pre-generation (and reuse) of ACK packets may be suitable because since the authentication packet signifies an FSK chip's intention to join the WiFi device's network, and the FSK chip is expected to acknowledge traffic from the device afterwards.

In the opposite direction, once the FM/FSK hardware sends a normal packet, the WiFi device should transmit an ACK packet. This packet can be used to implement the re-transmit logic. For example, once a packet is sent, the FM/FSK hardware may be transitioned to its transmit mode receiving mode immediately. If a valid ACK is received, the FM/FSK hardware may release the transmit buffer, transition into its receiving mode and copy more data from the upper layer. If no packet is received after a timeout, the FM/FSK hardware may re-transmit the packet. If a unicast (to FSK) packet is received, this indicates that the WiFi device and the FM/FSK hardware might be transmitting simultaneously. In such a case, the FM/FSK hardware may be configured to acknowledge the incoming packet, not release the transmit buffer, and transition into its receiving mode for more incoming packets.

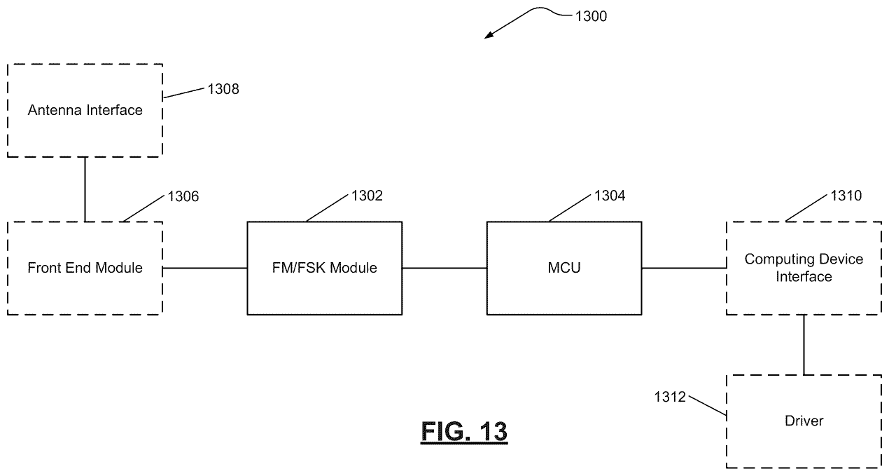

FIG. 11 illustrates an example timing diagram 1100 of data transmission/reception when RTS-CTS is employed. As shown, the diagram 1100 is similar to the diagram 1000 of FIG. 10, but includes a RTS duration (after the CSMA/CA duration) at the sender and a CTS duration (before the ACK duration) at the receiver. The implementation of RTS-CTS is substantially the same as ACK handling as explained above, since CTS is also expected to be transmitted one SIFS after RTS.

In the example of FIG. 11, the source may be a FSK device or a WiFi device, and the destination may be a WiFi device or a FSK device. Temporally, an FSK device may switch between the source and the destination.

FIG. 12 illustrates a finite state machine (FSM) diagram 1200 for a FM/FSK module, combining the implemented MAC layer (e.g., the CSMA/CA), the early termination of the reception of WiFi packets, and transitions between receive/transmit modes. For example, and as shown in FIG. 12, once in an Idle state, the FM/FSK hardware is configured to transition to either Tx or Rx immediately, depending on the value of txnext. Rx indicates that the FM/FSK hardware is in receive mode, but the SFD (e.g., 0x05AE4701) is yet to be detected. The CSMA/CA is implemented in the FSM diagram 1100 because the only way that txnext changes from 0 to 1 (thus initiating a new transmission), is that a) the FM/FSK hardware is in Rx and reaches timeout, b) no WiFi packet is detected, and c) no carrier is present in the medium. txnext turns to 0 or remains unchanged (e.g., during re-transmission) for all other paths.

The Rx Packet state indicates that a WiFi SYNC is detected and the FM/FSK hardware is actively collecting the data. Depending on the packet type, transmission of ACK or CTS may follow. In the case of packet errors, either in the PLCP header or the data field, the FM/FSK hardware may go to Idle and restart the process.

Additionally, the techniques implemented with any one of the FM/FSK modules disclosed herein may provide effective security measures. For example, WiFi security algorithms can be implemented with software. However, modern WiFi security frameworks (e.g., WPA2, WPA3, etc.) use advanced encryption standard (AES) and most CPUs include hardware to support AES instructions. Additionally, many microcontrollers (e.g., MCUs designed for IoT) also have hardware AES accelerators. The AES hardware helps efficiently encrypting and decrypting WiFi payloads.

The implemented FM/FSK modules may still provide effective security measures without WiFi encryption. For example, existing FSK protocols provide security without WiFi encryption. If an existing protocol encrypts the payload, the implemented FM/FSK modules may transmit the encrypted payload over open WiFi networks. On the other hand, since it allows devices to directly communicate via WiFi, the FM/FSK modules may provide stronger, enterprise-grade security protection by directly using the tried-and-true WiFi security framework on which billions of devices currently rely.

However, enablement of WiFi security such as WPA2-PSK is a common recommended setting employed in WiFi. Enabling WiFi security may incur only a small amount of overhead. For example, WPA2-PSK may incur an overhead of 16 bytes per packet, which is about 1% of a typical WiFi data packet (˜1500 bytes). Throughput may increase slightly using open networks. In practice, other factors such as background traffic and interference may outweigh the effect of WiFi security settings.

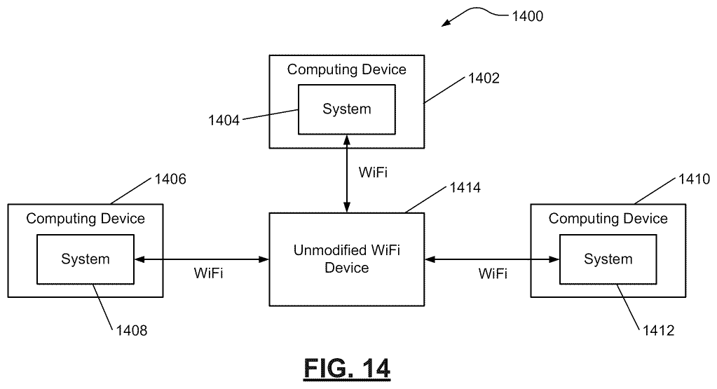

FIG. 13 illustrates an example system 1300 configurable to implement one or more of the teachings disclosed herein. In the example of FIG. 13, the system 1300 includes a FM/FSK module 1302 and a microcontroller (MCU) 1304. The module 1302 is designed for and intended to operate in a wireless protocol different than a WiFi protocol. For example, the module 1302 may operate in a wireless protocol having a narrower bandwidth than a WiFi protocol. Nonlimiting examples of the wireless protocol include a Bluetooth protocol (e.g., Bluetooth classic protocols, Bluetooth Low Energy (BLE) protocols, etc.), an IoT protocol, a FSK protocol, a Zigbee protocol, and/or another protocol that has a narrower bandwidth than a WiFi protocol. In some embodiments, the FM/FSK module 1302 and the MCU 1304 may be implemented as separate modules as shown in FIG. 13. In other examples, the FM/FSK module 1302 and the MCU 1304 may be implemented in the same module (e.g., the same chip). For example, the FM/FSK module 1302 may be incorporated inside the MCU chip.

In the example of FIG. 13, the FM/FSK module 1302 provides an interface between at least one unmodified WiFi device (e.g., any suitable device conforming to and operating according to the standard IEEE802.11 protocol) and a computing device configured to operate in accordance to a non-WiFi wireless protocol. For example, the computing device may be in communication with the FM/FSK module 1302, and configured to operate in accordance to a Bluetooth protocol (e.g., Bluetooth classic protocols, Bluetooth Low Energy (BLE) protocols, etc.), an IoT protocol, a FSK protocol, a Zigbee protocol, and/or another protocol that has a narrower bandwidth than a WiFi protocol. In some examples, the entire system 1300 (or one or more portions of the system 1300) may be a component (or components) physically located within the computing device. In other examples, the system 1300 (or one or more portions of the system 1300) may be located external to the computing device while remaining in communication with the computing device.

In FIG. 13, the FM/FSK module 1302 is configured to emulate direct reception of unmodified WiFi signals from one or more unmodified WiFi devices, and direct transmission of WiFi signals to the unmodified WiFi devices, as explained herein. For example, the FM/FSK module 1302 may include a receiver that receives any DSSS packet transmitted by a standard, unmodified WiFi transmitter without any WiFi payload selection or precoding process on the transmitter side and a transmitter that transmits standard DSSS WiFi packets, as explained herein. In such examples, firmware of the system 1300 may include, for example, instructions for implementing an FSM (e.g., the FSM 1200 of FIG. 12), descrambling, and frame check sequencing.

As shown in FIG. 13, the system 1300 may include various additional optional components. These components are shown with dashed lines in FIG. 13. For example, the system 1300 may further include a front-end module 1306, an antenna interface 1308, a computing device interface 1310, and/or a driver 1312 as shown in FIG. 13.

In the example of FIG. 13, the antenna interface 1308 is configured to couple to an antenna (not shown) for communicating with the one or more WiFi devices. For example, the antenna interface 1308 may include a connection (e.g., a coaxial connection, etc.) for interfacing with a corresponding connection on the antenna. In such examples, the antenna may receive the unmodified WiFi signals from the WiFi devices and transmit WiFi signals to the WiFi devices.

As shown, the front-end module 1306 of FIG. 13 is coupled between the antenna interface 1308 and the FM/FSK module 1302. The front-end module 1306 may include various components such as RF filters, RF amplifiers, etc. for processing signals received from and/or transmitted to the WiFi devices.

In FIG. 13, the computing device interface 1310 is configured to couple to the computing device. For example, the computing device interface 1310 may include a connection (e.g., a USB connection, etc.) for physically interfacing with a corresponding connection on the computing device. In such examples, the FM/FSK module 1302 may uncover data in the received unmodified WiFi signals, and pass such data to the computing device via the interface 1310. Additionally, the FM/FSK module 1302 may receive data from the computing device via the interface 1310, and package the data in WiFi signals for transmission to the WiFi devices (via the interface 1308 and the antenna).

The driver 1312 of FIG. 13 may provide a programming interface between the FM/FSK module 1302 and the computing device. In some examples, the driver 1312 may be an existing WiFi driver configurable for the computing device. In other examples, the driver 1312 may be a custom driver for interfacing the FM/FSK module 1302 with existing a software framework in the computing device.

For example, the driver 1312 may be a custom driver to interface the FM/FSK module 1302 with an existing driver application programming interface in the computing device. As one example, the custom driver may be a Linux kernel module to interface with an existing (e.g., unmodified) mac80211, which sits on top of WiFi drivers in modern Linux WiFi architecture. In such examples, the custom driver may be a very thin layer (e.g., less than 1,000 lines of code) that handles various mac80211 function calls, most notably ieee80211_tx and ieee80211_rx.

Additionally, the driver 1312 manages a queue that buffers outgoing packets. For example, packets may be popped off from the queue sequentially. In such examples, the driver 1312 then converts the packet to WiFi PSK bits by adding the PHY header and FCS, scrambling the entire packets and applying differential codings. These steps are simple bit operations and do not require a floating-point or DSP computation. For received packets, the driver 1312 may poll USB packets and check the FCS of the WiFi packet. If the check passes, the driver 1312 passes the packet to mac80211.

Further, in some embodiments, the driver 1312 and the firmware associated with the FM/FSK module 1302 may be configured to utilize existing WiFi components. For instance, the driver 1312 and the firmware may directly work with an unmodified mac80211 and upper layers associated with the computing device. For example, WiFi's MAC sublayer management entity (MLME) operations, such as scanning via probe requests, authenticating and associating with a WiFi device, are already implemented in mac80211. Additionally, protocols such as IP/ICMP and TCP/UDP may be implemented in the Linux kernel. Further, Linux (and Android) distributions may come with wpa_supplicant, an open-source WiFi security implementation. All these components work without modification. Therefore, the Internet works out-of-the-box once the driver 1312 is implemented.

FIG. 14 illustrates an example system 1400 including multiple computing devices 1402, 1406, 1410 and an unmodified WiFi device 1414. In the example of FIG. 14, each computing device 1402, 1406, 1410 is configured to operate in accordance to a non-WiFi wireless protocol, and includes a system 1404, 1408, 1412, respectively. The systems 1404, 1408, 1412 may be similar to the system 1300 of FIG. 13, and incorporate the teachings herein of direct reception of unmodified WiFi signals from the unmodified WiFi device 1414, and direct transmission of WiFi signals to the unmodified WiFi device 1414, as explained herein.

In the example of FIG. 14, the computing devices 1402, 1406, 1410 may include IoT applications, Bluetooth/BLE applications, and/or another non-WiFi wireless protocol. For example, the computing device 1402 may include IoT functionality the computing device 1406 may include Bluetooth/BLE functionality, and the computing device 1410 may include IoT and Bluetooth/BLE functionality.

The techniques implemented with any one of the FM/FSK modules disclosed herein may be employed in various applications. For example, the FM/FSK modules may be implemented with a single FSK chip or multiple FSK chips. These FSK chips are emulated as WiFi chips, and can communicate with conventional, unmodified WiFi devices/APs (providing unmodified WiFi signals), as explained herein. For example, to the network stack and the WiFi device(s), the implemented FM/FSK modules behave just like a conventional WiFi chip. Network applications can use the FM/FSK modules for Internet access without even recognizing the use of an FSK chip, instead of a WiFi chip. General web browsing works normally as well. In addition, the implemented FM/FSK modules can support streaming of high-quality audio and videos in real time.

As such, the teachings disclosed herein may be employed in various WiFi devices typically equipped with WiFi chips (from various different manufactures). For example, the FM/FSK modules (emulated as WiFi chips) may be employed as a general WiFi network interface controller (NIC), a reference for ultra-low-power WiFi designs, etc. Additionally, the teachings disclosed herein may be employed in classic Bluetooth, BLE (Bluetooth Low Energy), IoT devices, etc. Because FSK hardware is the foundation of Bluetooth communication, it is possible to simultaneously support Bluetooth, BLE and WiFi using one or more FSK chips.

By employing the teachings disclosed herein, energy-efficient solutions for directly communicating with unmodified WiFi devices is achieved. For example, FSK chips are extremely energy-efficient. Some FSK chips draw only about 19 mA in their transmit mode (at 0 dBm) and about 24 mA in their receive mode. By comparison, transmit current of conventional WiFi chips is typically measured at near 20 dBm, and employ external power amplifiers. The external amplifiers boost the signal to 20 dBm but draw 100 mA (at 3.3 V). Even considering an external amplifier, the overall power consumption is considerably lower than conventional WiFi chips. Further, the overall power consumption of the implemented FM/FSK modules is significantly reduced as compared to conventional USB WiFi cards. For example, the FM/FSK modules disclosed herein have a lower power consumption in Tx mode and Rx mode, after normalizing the baseline power consumption, as compared to conventional USB WiFi cards, when USB (5 V) supply current was measured during idle, continuous transmission and reception of 1 Mbps WiFi waveforms.

Additionally, the teachings disclosed herein enable excellent performance from physical-layer and system-level perspectives. For example, physical-layer performance such as packet error rate (PER) may be measured the WiFi-to-FSK direction and/or the FSK-to-WiFi direction. In the WiFi-to-FSK direction, the PER may be about 2.5% (and sometimes lower depending on the WiFi chip maker) at 20 m. In the FSK-to-WiFi direction, the PER may be about 1.9% (and sometimes lower depending on the WiFi chip maker) at 20 m. Additionally, with some WiFi chips, the PER (the FSK-to-WiFi direction) may be 0.07% at 20 m and 0% at 5 m.

For system-level evaluation, the FM/FSK modules may be tested with WiFi devices to measure performance at the transport layer. In such examples, TCP and UDP throughputs may be measured in one or both directions between the FM/FSK module (e.g., a FSK chip) and a WiFi device. For example, uplink TCP throughputs may range between about 615 kbps and 670 kbps at 20 m, between about 600 kbps and 660 kbps at 10 m, and between about 615 kbps and 650 kbps at 5 m. Uplink UDP throughputs may range between about 700 kbps and 710 kbps at 20 m, between about 690 kbps and 700 kbps at 10 m, and between about 695 kbps and 720 kbps at 5 m. Downlink TCP throughputs may range between about 700 kbps and 770 kbps at 20 m, between about 680 kbps and 770 kbps at 10 m, and between about 680 kbps and 770 kbps at 5 m. Downlink UDP throughputs may range between about 790 kbps and 860 kbps at 20 m, between about 800 kbps and 840 kbps at 10 m, and between about 790 kbps and 850 kbps at 5 m. Generally, UDP throughputs are higher than TCP throughputs because TCP requires additional TCP ACKs sent at the transport layer.

Further, testing has shown excellent round-trip time (RTT) between the FM/FSK module and WiFi devices over LAN and WAN. For example, for LAN, each tested WiFi device (connected the FM/FSK module) may be pinged, and for WAN, each tested WiFi device is connected to the Internet and the FM/FSK module may ping 8.8.4.4, Google's public DNS server. LAN and WAN RTT results may be similar when taking into account the ˜6 ms delay for traveling across the Internet for WAN. For example, for LAN, RTTs (at 20 m) may range between about 5 ms to about 10 ms, and for WAN, RTTs (at 20 m) may range between about 11 ms to about 16 ms.

To evaluate performance when the implemented FM/FSK module coexists with other WiFi devices, iperf3 may be used to measure the performance when 2 or 3 WiFi clients are simultaneously sending or receiving data. By default, iperf3 injects UDP data to and from each client at around 1.05 Mbps. In these cases, the channel is not saturated and all clients access the channel efficiently. The throughput of FSK does not decrease much in either direction. For TCP, iperf3 injects the data at the maximum speed, which saturates the channel. In these situations, any throughput gain at one client comes at the expense of the throughput decrease at another client. For example, for TCP uplink, one client of a three-client system may grab the channel less aggressively, and therefore the throughput of FSK does not decrease much. On the other hand, when the channel is saturated at the maximum, another client of the three-client system may grab the channel aggressively, and thus the FSK throughput drops. Even so, it does not starve to 0 and data can still go through. The throughput distribution may be fairer in the downlink direction since data is mostly sent by one WiFi device. In the two-client case, both throughputs may be roughly halved. Their throughputs may be further halved in the three-client case. In some examples, a fairer throughput distribution may be achieved by rate limiting, load balancing at the WiFi device, and/or implementing a point coordination function (PCF).

The techniques disclosed herein may also help develop future low-power WiFi transceivers. For example, instead of using a full-blown multi-rate PSK receiver with complicated phase synchronization, the relatively simple FM/FSK demodulator may be used to demodulate WiFi waveforms at 1 Mbps very effectively. Since 1 Mbps is frequently used to transmit management frames, the receiver can be completely turned off and only use low-power FM circuits to monitor the management traffic. The FM circuits can be used to wake up the main WiFi receiver after certain management frames (e.g., those containing traffic indication map (TIM)) are received.

Additionally, the techniques disclosed herein complement existing CTC by covering scenarios where users are not permitted to modify the firmware of WiFi devices (e.g., WiFi APs in public or enterprises), or where one FSK device may connect to many WiFi devices (e.g., roaming) arbitrarily without needing to modify the firmware of every single WiFi device.

Further, in contrast to the conventional IoT topology where gateways and devices employ similar radio circuitry and chips, the hardware of WiFi devices and FSK devices in the techniques disclosed herein is highly asymmetrical. This asymmetry provides an opportunity to use simple and energy-efficient FSK chips while still providing good performance by leveraging powerful PAs and LNAs in WiFi devices. In addition, WiFi's DSSS modulation at 1 Mbps has a higher coding gain than conventional systems such as Zigbee and Bluetooth, and is intrinsically robust. Moreover, to support higher data rates in newer 802.11 standards, many WiFi devices come with multiple antennas and advanced MIMO signal processing can further enhance the performance in both directions. Specifically, WiFi devices are allowed to transmit at high power and some WiFi devices support transmit beamforming for 802.11b, which enhances signal strength and overall mixed-client throughput. Also, many WiFi devices use diversity or MIMO processing (e.g., RAKE or MRC for 802.11b) to boost reception performance. For example, for 1 Mbps, modern WiFi devices may have a sensitivity as low as −102 dBm, which outperforms the latest Zigbee offerings from some manufactures even though WiFi is 4× faster than Zigbee (250 kbps). Compared to Bluetooth/BLE chips, the difference is even greater.

Moreover, the techniques disclosed herein may focus on transmitting/receiving data at 1 Mbps, which is on par with BLE 4 and 4× faster than Zigbee, and is sufficient for IoT operations. For WiFi, the 1 Mbps data rate has a special significance. For example, 1 Mbps has the most robust performance among possible WiFi modulations and many WiFi devices use 1 Mbps for management (beacon, association, authentication, etc.) frames regardless of the data rates of data frames. In a multi-rate environment (which is generally the case for typical WiFi networks), the transmit data rate is controlled by the rate adaptation algorithm (RAA), which will reduce the transmit data rates (i.e., use more robust modulation) if transmitted packets are not acknowledged. WiFi devices will try 1 Mbps modulation if transmitting with higher data rates is unsuccessful. Therefore, implementing 1 Mbps ensures that the WiFi-FSK connection will converge to a steady state using 1 Mbps. If only a higher data rate is supported instead, then a connection may not be able to be established because of the packet loss of management frames. In addition, even if the higher data rate is negotiated, any transient behavior in the network may cause two devices to diverge from the agreed-on data rate and thus cause disconnection.

Additionally, for the WiFi device, a terminal implementing the techniques disclosed herein may appear as a device that needs the most robust modulation and only 1 Mbps modulation can get through. Such a scenario can legitimately happen with a conventional WiFi terminal (e.g., with a weak signal or with strong interference). Therefore, rate adaptation algorithms should always support operations regardless of their actual implementation.

As used herein, a computing device may be any device that is connectable to a network. The computing device may include, for example, a laptop, a smartphone, a smart TV, a wearable device, etc. As used herein, a WiFi device is any suitable device conforming to and operating according to the standard IEEE802.11 protocol. In such examples, the WiFi device may be any device that allows other devices (e.g., a computing device, etc.) to connect to a WiFi network. In various embodiments, the WiFi device may include a standalone device, a multifunction device, and/or a controlled device. For example, the WiFi device may include an access point, a router, a WiFi hotspot device (e.g., a smartphone, a laptop, etc.), etc.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware. In various implementations, the functionality of the module may be distributed among multiple modules that are connected via the communications system.

Additionally, the term code may include software, firmware, and/or microcode, and may refer to computer programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The techniques described herein may be implemented by, for example, one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “descrambling” or “scrambling” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a tangible computer readable medium that can be accessed by the computer.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

1. A system comprising:
a module configured to operate in accordance to a wireless protocol that is different than a WiFi protocol and emulate direct transmission and reception of WiFi signals to and from an unmodified WiFi device, without payload selection or precoding on the unmodified WiFi device, the module including:
a receiver configured to receive, from the unmodified WiFi device, an unmodified first WiFi signal having an arbitrary data packet, the receiver including a narrowband filter and a narrowband demodulator, the narrowband filter configured to extract portions of the spectrum of the unmodified first WiFi signal from the unmodified WiFi device, and the narrowband demodulator configured to convert the extracted portions of the unmodified first WiFi signal into a plurality of bits to allow the receiver to recover the arbitrary data packet from the unmodified first WiFi signal for a computing device; and
a transmitter configured to transmit, to the unmodified WiFi device, a second WiFi signal.

2. The system of claim 1, wherein the receiver further comprises a descrambler coupled to the narrowband demodulator, and wherein the descrambler is configured to recover the data packet from the bits.

3. The system of claim 1, wherein the unmodified first WiFi signal has a first frequency, and wherein the receiver is configured to operate at a frequency shifted by a defined amount with respect to the first frequency of the unmodified first WiFi signal.

4. The system of claim 1, wherein the unmodified first WiFi signal has a first frequency, and wherein the receiver is configured to operate at a frequency equal to the first frequency.

5. The system of claim 1, wherein the receiver is configured to recognize the data packet by detecting a defined bit sequence in the unmodified first WiFi signal.

6. The system of claim 1, wherein the second WiFi signal includes a data packet having a plurality of bits and wherein the transmitter is a narrowband transmitter configured to transmit the second WiFi signal by shifting a phase of the narrowband transmitter based on the plurality of bits of the data packet.

7. The system of claim 6, wherein the narrowband transmitter includes at least one of a mixer, a phase shifter, or a phase lock loop (PLL) configured to shift the phase of the narrowband transmitter.

8. The system of claim 6, wherein the narrowband transmitter is a Frequency-Shift Keying (FSK) transmitter.

9. The system of claim 1, wherein the receiver is configured to terminate the reception of the data packet before the data packet is entirely received.

10. The system of claim 1, wherein the narrowband demodulator is a Frequency-Shift Keying (FSK) demodulator or a Phase-Shift Keying (PSK) demodulator.

11. The system of claim 1, further comprising a computing device in communication with the module, the computing device configured to operate in accordance to the at least one non-WiFi wireless protocol.

12. The system of claim 11, wherein the at least one non-WiFi wireless protocol includes one of a Bluetooth protocol or an Internet of things (IoT) protocol.

13. A receiver of a module configured to emulate direct reception of an unmodified WiFi signal from an unmodified WiFi device, the receiver comprising a narrowband filter and a narrowband demodulator, the receiver configured to operate in accordance to a wireless protocol different than a WiFi protocol and receive the unmodified WiFi signal having an arbitrary data packet from the unmodified WiFi device, without payload selection or precoding on the unmodified WiFi device, the narrowband filter configured to extract portions of the spectrum of the unmodified WiFi signal received from the unmodified WiFi device, and the narrowband demodulator configured to convert the extracted portions of the unmodified WiFi signal into a plurality of bits to allow the receiver to recover the arbitrary data packet from the unmodified WiFi signal.

14. The receiver of claim 13, wherein the receiver further comprises a descrambler configured to recover the arbitrary data packet from the bits.

15. The receiver of claim 13, wherein the unmodified WiFi signal has a first frequency, and wherein the receiver is configured to operate at a frequency shifted by a defined amount with respect to the first frequency of the unmodified WiFi signal or at a frequency equal to the first frequency.

16. The receiver of claim 13, wherein the receiver is configured to recognize the data packet by detecting a defined bit sequence in the unmodified WiFi signal.

17. The receiver of claim 13, wherein the narrowband demodulator is a Frequency-Shift Keying (FSK) demodulator or a Phase-Shift Keying (PSK) demodulator.

18. A transmitter of a module configured to emulate direct transmission of a WiFi signal having a standard direct-sequence spread spectrum (DSSS) data packet to an unmodified WiFi device, the transmitter comprising at least one component configured to shift a phase of the transmitter based on a plurality of bits of the DSSS data packet, the transmitter configured to operate in accordance to a wireless protocol different than a WiFi protocol and transmit the WiFi signal having the DSSS data packet to the unmodified WiFi device.

19. The transmitter of claim 18, wherein the at least one component of the transmitter includes at least one of a mixer, a phase shifter or an RF switch configured to shift the phase of the transmitter based on the plurality of bits of the DSSS data packet.

20. The transmitter of claim 18, wherein the transmitter is a Frequency-Shift Keying (FSK) transmitter.
